(19) United States
(12) Patent Application Publication
(10) Pub. No.: US 2024/0160477 A1
(43) Pub. Date: May 16, 2024

(54) Dynamic Virtual Channel Allocation for Time Sensitive Networking Bus

(71) Applicant: Micron Technology, Inc., Boise, ID (US)

(72) Inventors: Poorna Kale, Folsom, CA (US); Saideep Tiku, Folsom, CA (US); Wilbert Justino C. Florentino, San Jose, CA (US)

(21) Appl. No.: 18/492,138

(22) Filed: Oct. 23, 2023

Related U.S. Application Data
(60) Provisional application No. 63/383,193, filed on Nov. 10, 2022.

(51) Int. Cl. G06F 9/50; G06F 13/36

(52) U.S. Cl. CPC G06F 9/5011; G06F 13/36

(57) ABSTRACT

A computing system, having: a plurality of components operable to perform computing tasks; a plurality of memory devices operable to provide memory and storage services to the computing tasks; a network of physical connections configured between the components and the memory devices to form a bus for the computing tasks to access the memory and storage services; and a network manager configured to allocate virtual channels, through the bus, for the computing tasks to access the memory and storage services with deterministic timing.

### RELATED APPLICATIONS

The present application claims priority to Prov. U.S. Pat. App. Ser. No. 63/383,193 filed Nov. 10, 2022, the entire disclosures of which application are hereby incorporated herein by reference.

### TECHNICAL FIELD

At least some embodiments disclosed herein relate to computer communications in general and more particularly, but not limited to, virtual channel allocation for communications over time sensitive networking bus.

### BACKGROUND

Some applications, such as the streaming of audio and video content for playing back over a computer network, are sensitive to delay and its variations in data delivery over the computer network. When a data consuming application (e.g., a media player) fails to receive a piece of data from a data transmission application (e.g., a content streamer) in time for the use of the piece of data, synchronization between the applications is broken, causing a glitch in the data consuming application. Buffering is typically used to reduce the likelihood of a piece of data failing to arrive timely.

Time sensitive networking includes techniques for time synchronization among devices involved in communications over a network, techniques for scheduling and traffic shaping, and techniques for selection of communication paths, path reservations and fault-tolerance.

A computing system can be configured to include a number of components connected via a number of connections to memory sub-systems. For example, connections according to compute express link (CXL) can be used to provide high-speed connections among a central processing unit (CPU), memory, a graphics processing unit (GPU), etc.

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The embodiments are illustrated by way of example and not limitation in the figures of the accompanying drawings in which like references indicate similar elements.

FIG. 1 shows a computing system having a network manager configured to dynamically allocate virtual channels for communication over a time sensitive networking bus according to one embodiment.

FIG. 2, FIG. 3, and FIG. 4 illustrate examples of dynamic allocations of virtual channels for communication over a time sensitive networking bus according to one embodiment.

FIG. 5 shows an analog compute module having a dynamic random access memory, a non-volatile memory cell array, and circuits to perform inference computations according to one embodiment.

FIG. 6 and FIG. 7 illustrate different configurations of analog compute modules according to some embodiments.

FIG. 8 shows the computation of a column of weight bits multiplied by a column of input bits to provide an accumulation result according to one embodiment.

FIG. 9 shows the computation of a column of multi-bit weights multiplied by a column of input bits to provide an accumulation result according to one embodiment.

FIG. 10 shows the computation of a column of multi-bit weights multiplied by a column of multi-bit inputs to provide an accumulation result according to one embodiment.

FIG. 11 shows an implementation of artificial neural network computations according to one embodiment.

FIG. 12 shows a controller logic circuit using an inference logic circuit in multiplication and accumulation computation according to one embodiment.

FIG. 13 shows a method of managing a time sensitive networking bus according to one embodiment.

### DETAILED DESCRIPTION

At least some embodiments disclosed herein provide techniques to use a network manager to dynamically allocate virtual channels over a time sensitive networking bus to satisfy the timing requirements of computing tasks running to access, via the bus, memory sub-systems.

For example, a computing system can have a plurality of components operable as computing agents to perform computing tasks (e.g., via running applications or executing routines). The computing system can have a plurality of memory devices connected via a time sensitive networking bus to provide memory services and storage services for the computing tasks. The time sensitive networking bus can include a set of physical connections from the components/computing agents to memory devices. For example, the connections can be in accordance with computer express link (CXL), peripheral component interconnect express (PCIe), ethernet, or other communications standards. The physical connections can be arranged to have a topology of a network with redundant paths, or alternative paths, or both. The memory devices can have different latencies in performing read and write operations; and communication congestion over certain physical connections in the bus during certain time periods can impact the delay in communications over possible routes/paths in the bus.

A network manager can be configured on the time sensitive networking bus to dynamically allocate or configure virtual channels for communications among the components and the memory devices over the time sensitive networking bus.

A virtual channel can specify a set of rules for communications over the time sensitive networking bus for a component or agent to access a memory/storage service. Devices and physical connections involved in the implementation of the virtual channel are required to perform communication operations according to the rules such that the timing and delay over the virtual channel can be deterministic and guaranteed to satisfy the timing requirements of the component agent. Optionally, a memory/storage service can be virtualized for hosting on one or more of the memory devices connected to the time sensitive networking bus. Optionally, or in combination, a computing agent can also be virtualized and hosted on one or more of the components. In general, there can be a large number of solution candidates in resource allocation and rule formulation to set up and optimize virtual channels for improved performance of the computing system as a whole.

Components on a time sensitive networking bus can be configured to communicate with each other, or cooperate with each other, or both, through the services of memory devices connected on the timing sensitive networking bus. The components or computing agents can be configured to identify timing data indicative of the urgency levels, timing requirements, etc., of computing tasks (e.g., to be performed via running applications or executing routines) in accessing the memory devices for memory/storage services. The timing data can be communicated to the network manager; and the network manager can schedule and shape communication traffic over the time sensitive networking bus via the dynamic allocation of virtual channels to compensate for network delays and congestion in meeting the timing requirements in a deterministic way and in improving or optimizing system performance in view of urgency levels of the computing tasks.

The workloads and deadlines of computing tasks in accessing memory/storage services over the time sensitive networking bus can change. The network manager can dynamically adjust virtual channel allocations in the bus to guarantee that communications over the virtual channels satisfy the timing requirements based on which the virtual channels are allocated. When there are insufficient resources to allocate a virtual channel to meet the timing requirement of a computing task, the allocation of the virtual channel is delayed. Optionally, when an urgent task requires resources for a virtual channel, the usage of an existing virtual channel allocated to a task having a lower urgency level can be paused to free up resources for the urgent task, or reallocated to use a different set of resources, or reconfigured to satisfy modified timing requirements. In some instances, resources can be reallocated among allocated virtual channels to free up resources to allow an additional virtual channel to be allocated and meet the timing requirements of a new computing task. When resources become available (e.g., upon completion of a computing task, reallocation or modification of an existing virtual channel, pausing of an existing virtual channel), the allocation of the virtual channel that has been delayed can be performed.

Optionally, each computing agent maintains an urgency level for its workload or computing task associated with running an application or routine in accessing memory/storage resources. The network manager orchestrates the virtual channel allocation based on the requirements of various computing agents and the urgency levels to prioritize resource allocation for virtual channels and to improve or maximize the overall performance of the system.

The computations of a virtual channel allocation can include the determination of the communication rules for one or more physical connections in the time sensitive networking bus. The validity or selection of the communication rules can be limited by the workloads of the devices involved in the physical connections and the capabilities of the devices and connections in handling communications, in implementing low, deterministic delays that satisfy the timing requirements of the computing task.

The network manager can be configured to perform inference computations in the determination, selection, search, optimization of the communication rules for the allocation and adjustment of virtual channels. Optionally, the network manager can optimize the performance of the system as a whole through the prediction of the workloads of the time sensitive networking bus, such as the timing of computing tasks to be performed, the urgency levels of the computing tasks, the bandwidth usages of the computing tasks, the durations of the computing tasks, the access latency requirements of the computing tasks, etc.

For example, when the computing system is used to perform routine or similar tasks over a period of time, there can be patterns in the computing tasks; and an artificial neural network can be trained, via the activity and timing data collected during the period of time to predict computing tasks that will use the time sensitive networking bus in a subsequent period of time, and predict the attributes of the computing tasks (e.g., urgency levels, latency requirements, bandwidth usages). By performing virtual channel allocation in view of the predicted computing tasks, the network manager can optimize the overall performance of the system (e.g., by avoid allocation of virtual channels to tasks of low urgency levels that may block the allocation of virtual channels to tasks of high urgency levels).

Optionally, the network manager can adjust the hosting of memory/storage services on memory devices for computing tasks in adjusting the allocation of virtual channels in use. For example, a computing task initially provisioned to use a memory device for memory/storage services can be provided access to use alternative memory devices for subsequent memory/storage services to free up the initially provisioned memory devices (and their connectivity) for another task.

Optionally, or in combination, the network manager can adjust the hosting of computing tasks on computing components in adjusting the allocation of virtual channels in use. For example, a computing task implemented via running an application or routine initially running on a component can be moved to an alternative component.

In general, adjustments of the hosting of memory/storage services and computing tasks can change resource availability across the time sensitive networking bus and free up resources (e.g., available connectivity and bandwidth of physical connections, memory/storage services) for the allocation of a new virtual channel for an urgent computing task for improved overall performance of the system.

The network manager can be configured to perform inference computations in moving computing tasks among computing agents/components available in the system, adjusting allocation of memory/storage services to the computing tasks, reserving resources for predicted computing tasks of high urgency levels, etc. The inference computations can be performed during virtual channel allocation or adjustment, in view of known or predicted (or both types of) resource restrictions (e.g., communication congestion, bandwidth and latencies of physical connections).

The network manager can be configured to include an inference logic circuit to accelerate the inference computations in the virtual channel allocation. For example, the inference logic circuit can include multiplier-accumulator units that are configured to perform at least part of multiplication and accumulation operations in an analog form.

For example, the network manager can include an analog compute module having an array of memory cells programmable in a synapse mode to support multiplication and accumulation operations in an analog form. Alternatively, a memristor crossbar array can be used to accelerate multiplication and accumulation operations in an analog form. Alternatively, multiple sets of logic circuits can be configured in a form of arrays to perform multiplications and accumulations in parallel to accelerate multiplication and accumulation operations.

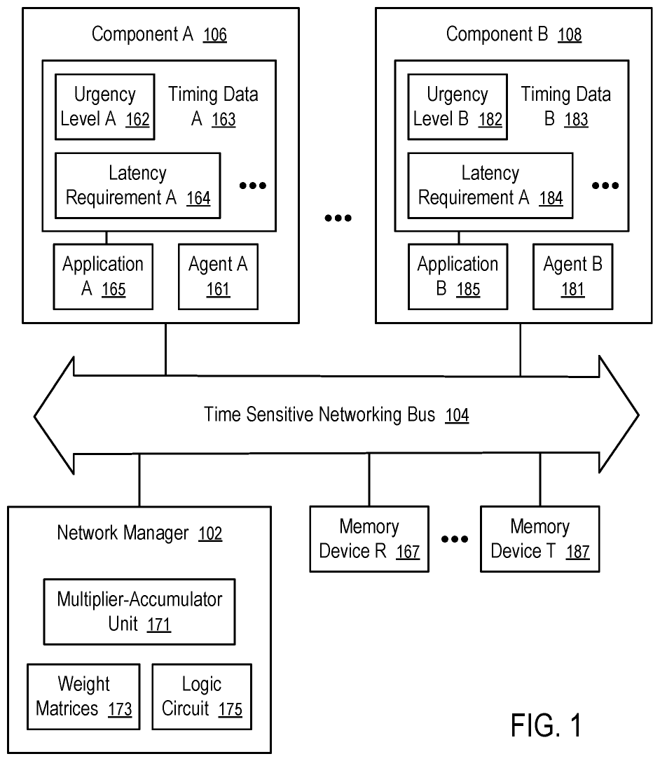

FIG. 1 shows a computing system having a network manager 102 configured to dynamically allocate virtual channels for communication over a time sensitive networking bus 104 according to one embodiment.

In the computing system of FIG. 1, the time sensitive networking bus 104 has multiple physical connections among components 106, . . . , 108 and memory devices 167, . . . , 187. The physical connections can have a topology of a network with redundant paths, or alternative paths, or both to reach computing resources, or memory/storage resources, or both. Optionally, some of the memory devices 167, . . . , 187 can be configured to provide caching services, buffering services, etc.

Each physical connection can connect one or more of the devices (e.g., one or more of components 106, . . . , 108 and memory devices 167, . . . , 187). Such a connection can be in accordance with computer express link (CXL), peripheral component interconnect express (PCIe), ethernet, or other communications standards.

The physical connections form a network with multiple alternative ways to service a component (e.g., 106 or 108) in running an application (e.g., 165 or 185) (e.g., a computing task, a routine of operations). Optionally, the time sensitive networking bus 104 can include switches, hubs, etc., for improved flexibility in configuring virtual channels. In some instances, a computing task can be implemented in multiple ways (e.g., via an application 165 running in a component 165, or the same application 165 or another application 185 running in another component 185).

Each component (e.g., 106 or 108) in the system can have an agent (e.g., 161 or 181) that identifies timing data (e.g., 163 or 183) of the computing tasks (e.g., application 165 or 185) running in the component (e.g., 106 or 108) to support the scheduling and shaping of traffic in the time sensitive networking bus 104.

For example, the timing data 163 of the application 165 running in the component 106 can specify the urgency level 162 of the application 165 in accessing the time sensitive networking bus 104. Resources of the time sensitive networking bus 104 can be allocated or provisioned, e.g., in the form of virtual channels, according to priorities indicated by the urgency level 162. Further, the time data 163 can include the latency requirement 164 of the application 165 in accessing memory/storage services (e.g., provided via the memory devices 167, . . . , 187) over the time sensitive networking bus 104. In some situations, the component 106 can change the latency requirement 164 based on resources (e.g., buffer memory) available in the component 106 for the application 165.

Optionally, the timing data 163 can further include an indication of the duration of a virtual channel to be used by the application 165, an amount of bandwidth to be used by the application 165 in communications through the virtual channel, etc. Such communication attributes can be used to improve or optimize the usages of resources in the allocation or adjustment of virtual channels in the time sensitive networking bus 104.

Similarly, the agent 181 in the component 108 can identify timing data 183 for the application 185 running in the component 108, including the urgency level 182 of communications of the application 185 in accessing the memory/storage services over the time sensitive networking bus 104, the latency requirement 184 of the communications over the time sensitive networking bus 104, etc.

In some implementations, an agent (e.g., 161) can predict some aspects of its timing data (e.g., 163), such as a need to run or start an application (e.g., 165) at a predicted time instance or time window and thus the timing for the allocation of a virtual channel for the application (e.g., 165), the bandwidth and duration of the application (e.g., 165) using the time sensitive networking bus 104, etc. For example, an artificial neural network can be trained based on past application activities in a component (e.g., 106) (or in the computing system as a whole) to predict such aspects for a subsequent time duration. Alternatively, the network manager 102 can be configured to make the predictions to optimize allocation of virtual channels for applications (e.g., 165, 185) for improved performance for the system as a whole.

The agents (e.g., 161, . . . , 181) can communicate the timing data (e.g., 163, 183) to the network manager 102. For example, the timing data 163 can be communicated to the network manager 102 in connection with a request to open a virtual channel for the application 165. For example, the timing data 163 can be communicated to the network manager 102 in response to a prediction to run the application 165 for the planning of allocation of a virtual channel for the application 165.

In some implementations, the components 106, . . . , 108 (and optionally the network manager 102) can communicate with each other to negotiate the hosting of an application (e.g., 165) in a component (e.g., 106). Thus, there can be multiple options to perform a computing task (e.g., in component 106, or in component 108, or via both components 106 and 108).

The network manager 102 can include a logic circuit 175 configured to perform the computations for allocation, reservation, adjustments of a virtual channel in the time sensitive networking bus 104 to meet the requirement of the timing data (e.g., 163 or 183) specified for an application (e.g., 165 or 185), in view of virtual channels that have been in allocated and in use, or reserved for applications having high levels of urgency.

The identification of a virtual channel in the time sensitive networking bus 104 can include the identification of a set of rules to implement a fixed delay (or a maximum allowable delay) in communications for an application (e.g., 165) to access memory/storage services hosted on a memory device (e.g., 167 or 187). The rules can include the identification of the use of one or more physical connections in the time sensitive networking bus 104, the timing for the communications handled for the virtual channel by the component(s) or memory device(s) involved in the physical connections, etc., such that when communications are performed according to the rules, the timing requirements (e.g., latency requirement 164) are guaranteed to be satisfied.

When meeting the timing requirement for a virtual channel cannot be guaranteed (e.g., for lack of sufficient resources in the time sensitive networking bus 104), the opening of the virtual channel can be delayed until sufficient resources are freed up (e.g., via the closing or restructuring of one or more virtual channels, the change of a timing requirement for a virtual channel, etc.).

To optimize the performance of the system, the network manager 102 can be configured to prioritize the allocation of virtual channels for computing tasks having high levels of urgency. Optionally, the computing system can be configured to pause the usages of virtual channels being allocated to computing tasks having low urgency levels to free up resources for the allocation of virtual channels for computing tasks of high urgency levels.

The computations performed for the allocation and adjustment of virtual channels in the time sensitive networking bus 104, and the predictions of application activities and requirements, can involve multiplication and accumulation operations, such as the operations of artificial neural networks.

The network manager 102 can include one or more multiplier-accumulator units 171 to accelerate the multiplication and accumulation operations and thus the computations to be performed by the network manager 102. For example, the network manager 102 can store a set of weight matrices 173, such as the weight matrices of an artificial neural network, and apply inputs against the weight matrices 173 using the multiplier-accumulator unit 171 in performing computations in making predictions, determining rules of virtual channels, searching for solutions to reorganize virtual channels for allocation of a new virtual channel, etc.

Optionally, the network manager 102 is implemented in a stand-alone component that has the logic circuit 175, multiplier-accumulator units 171, and weight matrices 173. In some implementations, the logic circuit 175 is programmed via instructions to perform the computations of the network manager 102.

Alternatively, one of the components (e.g., 106 or 108) can be configured with the logic circuit 175, multiplier-accumulator units 171, and weight matrices 173 to perform the computations of the network manager 102 as an add-on task.

Alternatively, one of the memory devices (e.g., 167 or 187) can be configured with the logic circuit 175, multiplier-accumulator units 171, and weight matrices 173 to perform the computations of the network manager 102 as an add-on service.

Alternatively, at least a portion of the computations of the network manager 102 can be distributed to agents (e.g., 161, 181) across the components 106, . . . , 108 and the memory devices 167, . . . , 187; and the agents (e.g., 161, 181) can cooperate with each other in implementing the network manager 102 as a whole. Thus, the implementation of the network manager 102 is not limited to an example of a dedicated, stand-alone component/device configured on the time sensitive networking bus 104.

In some implementations, the logic circuit 175, the multiplier-accumulator unit 171, and the weight matrices 173 are implemented at least in part via an analog compute module, as further discussed below.

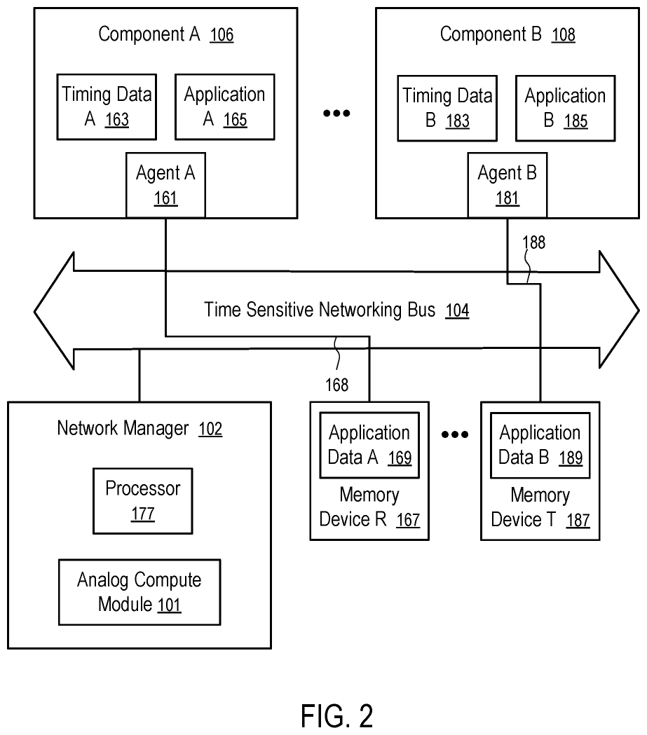

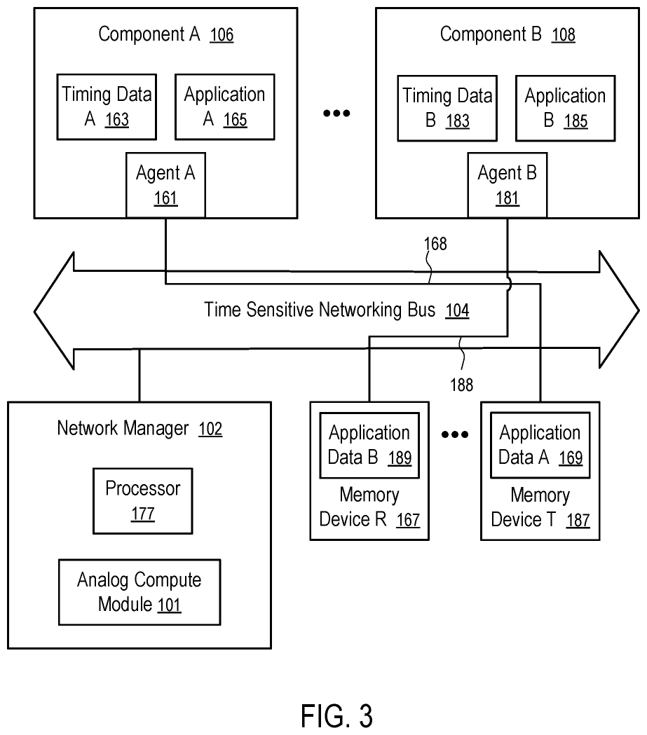

FIG. 2, FIG. 3, and FIG. 4 illustrate examples of dynamic allocations of virtual channels for communication over a time sensitive networking bus according to one embodiment. For example, the dynamic allocations of virtual channels as illustrated in FIG. 2, FIG. 3, and FIG. 4 can be implemented in the computing system of FIG. 1.

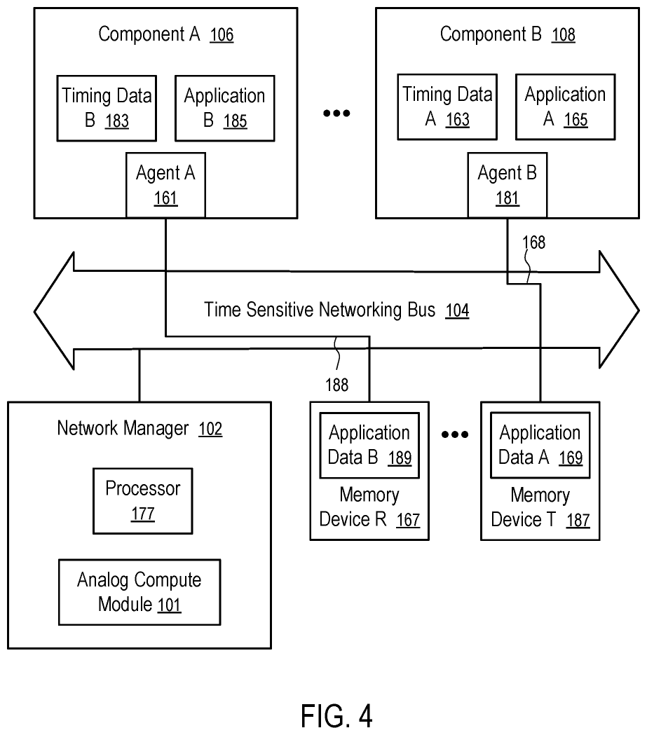

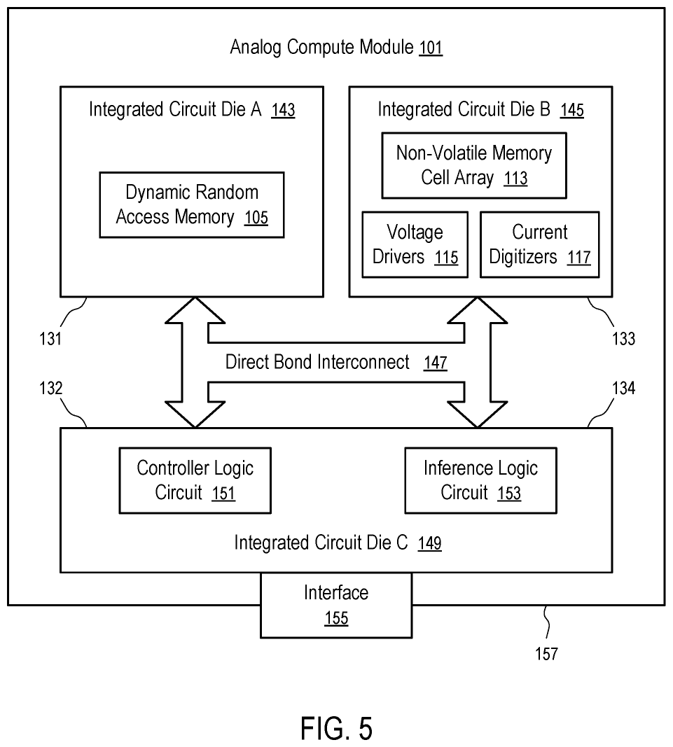

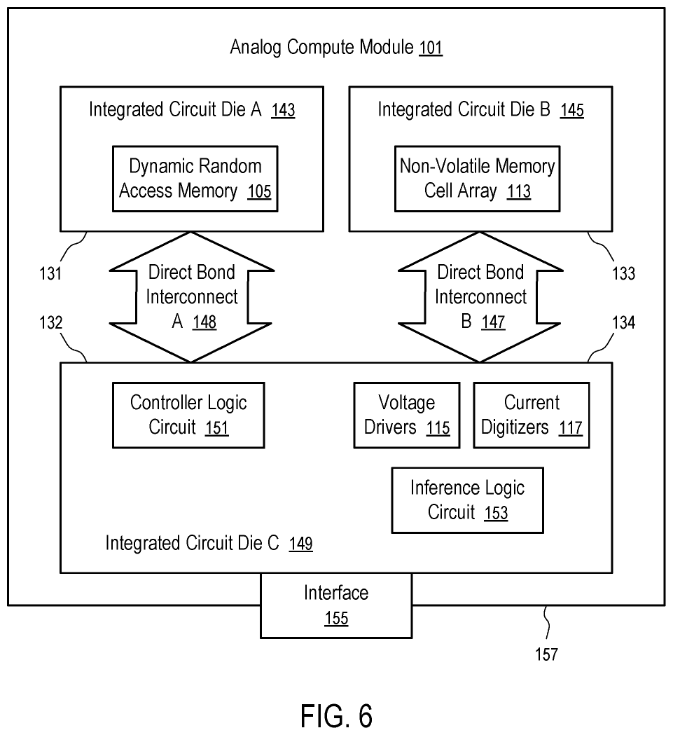

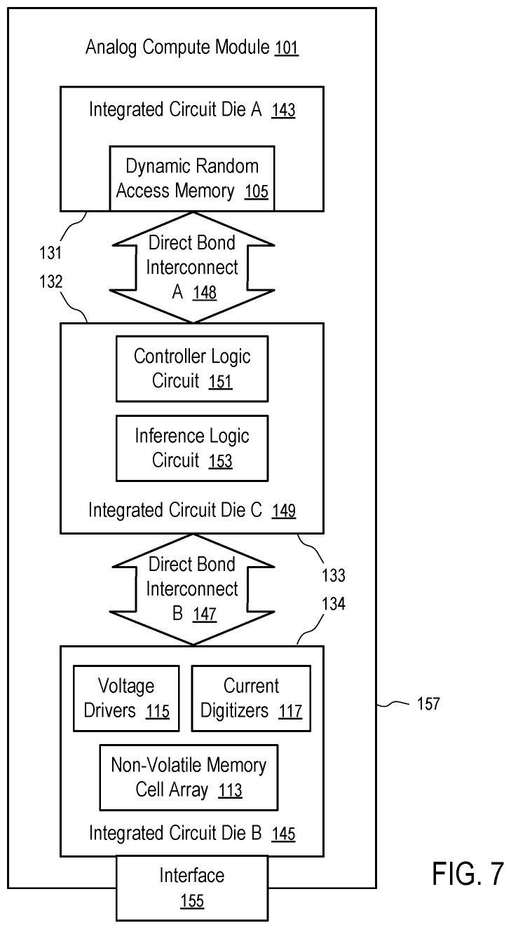

In FIG. 2, FIG. 3, and FIG. 4, the network manager 102 includes a processor 177 programmed to perform dynamic allocations of virtual channels according to a set of instructions. The instructions can be programmed to use an analog compute module 101 to perform multiplication and accumulation. For example, analog compute module 101 illustrated in FIG. 5, FIG. 6, and FIG. 7 can be used.

For example, when the application 165 running the component 106 is in need for a connection to access a memory/storage service in the memory devices 167, . . . , 187, the network manager 102 can allocate a virtual channel 168 through the time sensitive networking bus 104 to access a portion of the memory device 167 for data 169 of the application 165. The virtual channel 168 includes the identification of a set of physical connections in the time sensitive networking bus 104 and a set of rules for devices involved in the set of physical connections to perform operations such that the delay and latency of communications over the virtual channel 168 is deterministic according to the time data 163 of the application 165.

In response to another application 185 running the component 108 is in need for a connection to access a memory/storage service in the memory devices 167, . . . , 187, the network manager 102 can allocate a virtual channel 188 through the time sensitive networking bus 104 to access a portion of the memory device 187 for data 189 of the application 185. When the time sensitive networking bus 104 has sufficient resources to satisfy the requirements identified in the timing data 163 and 183 for the applications 165 and 185, the network manager 102 can allocate the virtual channel 188 without modifying the virtual channel 168. The virtual channel 188 includes the identification of a set of physical connections in the time sensitive networking bus 104 and a set of rules for devices involved in the set of physical connections to perform operations such that the delay and latency of communications over the virtual channel 188 is deterministic according to the time data 183 of the application 185. In some instances, the virtual channels 168 and 188 can share a portion of the physical paths through the time sensitive networking bus 104, such as a switch, a hub, a cache, a buffer, or a physical connection/wire, etc., when the shared portion is sufficient to meet the demands of the timing data 163 and 183 when operating according to the rules specified for the virtual channels 168 and 188.

However, in some instances, when the time sensitive networking bus 104 has insufficient resources to satisfy the requirements of the timing data 183 without modifying the virtual channel 168 (e.g., due to the latency of memory device 187 and/or the physical connection available for communicating with the memory device 187), the network manager 102 can adjust the allocation of the virtual channel 168 to accommodate the needs of the application 185 (e.g., when the urgency level 182 of the application 185 is higher than the urgency level 162 of the application 165).

For example, as illustrated in FIG. 3, the network manager 102 can cause the move of the hosting of data 169 of the application 165 from the memory device 167 to the memory device 187 to free up resources for the allocation of a virtual channel 188 to the memory device 167 so that the requirements in the timing data 183 of the application 185 are satisfied.

Optionally, the network manager 102 can negotiate with the agent 161 in the component 106 to reduce the timing requirements (e.g., latency requirement 164) of the application 164 to facilitate the modification of the virtual channel 168.

Optionally, the network manager 102 can request the application 165 to pause the use of the virtual channel 168 as allocated in FIG. 2 for a period of time to accommodate the change.

In general, the modification of the virtual channel 168 (and the pause of its usage) can cause delay and performance degradation for the application 165. However, when the application 185 has an urgency level 182 higher than the urgency level 162 of the application 165, it can be beneficial for the improvement of the overall performance of the computing system.

In general, the time sensitive networking bus 104 can have a plurality of active virtual channels (e.g., 168) when there is a need to allocate a new virtual channel (e.g., 188) for an application (e.g., 185). The network manager 102 can search for a solution, among possible options, that improves or optimizes the performance of the computing system as a whole.

In some implementations, the network manager 102 or an agent (e.g., 181) can predict the need to run an application (e.g., 185); and the network manager 102 can select a virtual channel (e.g., 168) and prepare the modification of the selected virtual channel (e.g., 168) to minimize the disruption to the application (e.g., 165) that uses the selected virtual channel (e.g., 168).

Optionally, the network manager 102 or an agent (e.g., 181) can predict certain aspects or requirements of the timing data 183 of the application 185 (e.g., communication bandwidth usages of the application 185, permissible adjustments to requirements for latency, permissible adjustments urgency levels). For example, a predictive model or an artificial neural network can be trained using past activities of the computing system to make the predictions for a subsequent period of time; and the predictions can be used to find an optimized solution for dynamic allocations and modifications of virtual channels (e.g., 168, 188).

In some implementations, the network manager 102 can communicate with the agents 161, . . . , 181 to negotiate the host of applications (e.g., 165, 185). Thus, the modification of the virtual channel 168 to accommodate the allocation of a virtual channel 188 can include a change of hosting of one or more applications, as illustrated in FIG. 4.

For example, for improved performance of the system as a whole, the host of the application 185 can be moved from the component 108 (as in FIG. 2) to the component 106 (as in FIG. 4). Similarly, the host of the application 165 can be moved from the component 106 (as in FIG. 2) to the component 108 (as in FIG. 4). The adjustment of the hosting of the applications (e.g., 165 and 185) can free up resources for the adjustment of the virtual channel 168 used by the application 165 and for the allocation of the virtual channel 188 for the application 185. Optionally, the hosting of the data (e.g., 169 and 189) of the applications (e.g., 165 and 185) can be changed as well, as illustrated in FIG. 4.

Options for the adjustments of the hosting of the application data (e.g., 169, 189), and the options for the adjustments of the hosting of the applications (e.g., 165, 185) can increase the flexibility in dynamic allocation/modification of virtual channels (e.g., 168 and 188) in the time sensitive networking bus 104. The options can also increase the complexity of the computations in finding a solution with improved or optimized performance for the computing system as a whole. Inferences computations (e.g., configured based on artificial neural networks and predictive models) can be used to balance the performance in the speed to find a solution and the performance in the quality of the solution that minimizes disruption and improves the overall performance of the computing system.

The analog compute module 101 of the network manager 102 can be implemented as an integrated circuit device as in FIG. 5, FIG. 6, and FIG. 7.

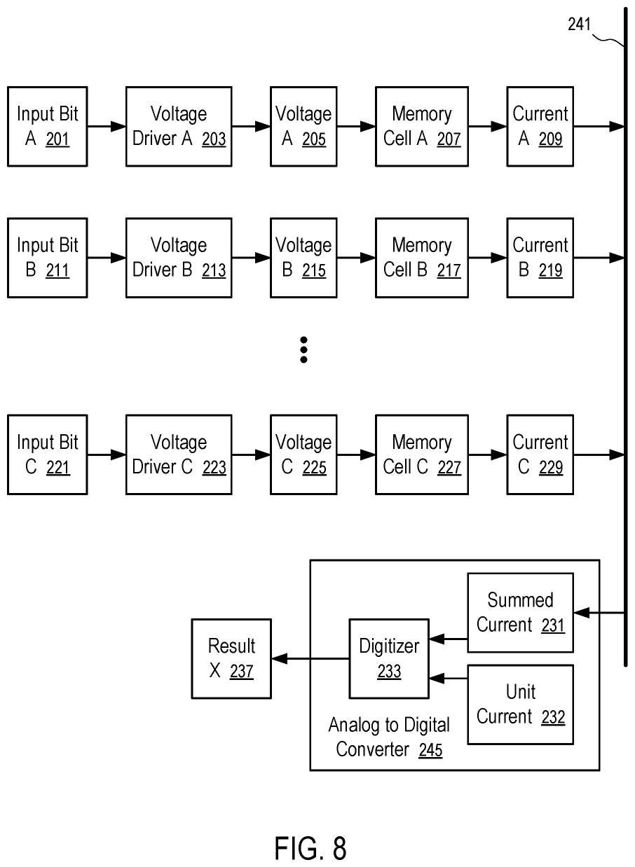

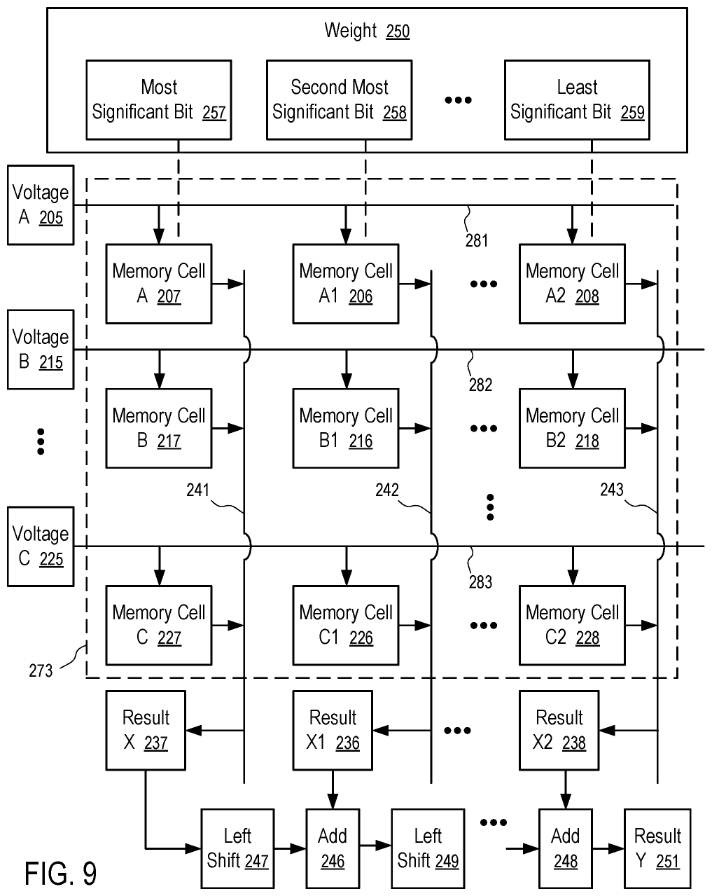

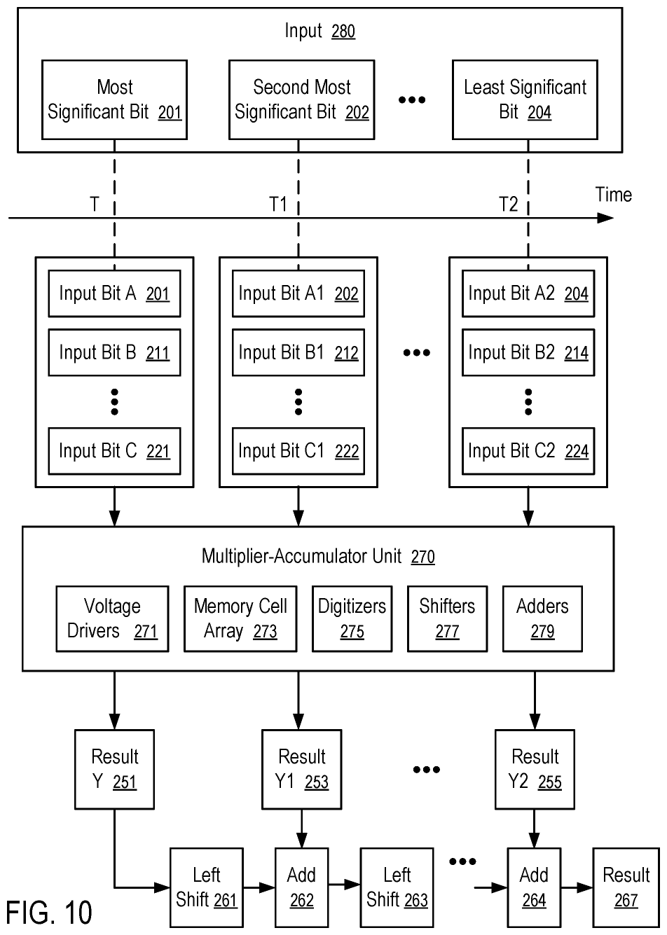

For example, a non-volatile memory cell array in the analog compute module 101 can be programmable in a synapse mode to store weight matrices 173 for multiplication and accumulation operations, as further discussed in connection with FIG. 8, FIG. 9, and FIG. 10. The analog compute module 101 has voltage drivers and current digitizers. During multiplication and accumulation operations, the analog compute module 101 can use the voltage drivers to apply read voltages, according to input data, onto wordlines connected to memory cells programmed in the synapse mode to generate currents representative of results of multiplications between the weight data and the input data. The currents are summed in an analog form in bitlines connected to the memory cells programmed in the synapse mode. The current digitizers can convert the currents summed in bitlines to digital results.

Optionally, a portion of the non-volatile memory cell array 113 can be programmed in a storage mode to store data, such as the timing data 163, . . . , 183 of the applications 165, . . . , 185. Memory cells programmed in the storage mode can have better performance in data storage and data retrieval than memory cells programmed in the synapse mode, but can lack the support for multiplication and accumulation operations.

Optionally, one or more of the memory devices 167, . . . , 187 can include an analog compute module 101 to provide memory/storage services using its memory cell array and optionally provide a service of multiplication and accumulation.

For example, data is written into a predefined region of memory addresses in the analog compute module 101, the analog compute module 101 can use as weight data to program a region of its non-volatile memory cell array in the synapse mode. When input data is written into another predefined region of memory addresses in the analog compute module 101, the analog compute module 101 can use the input data to read the region of the non-volatile memory cell array, programmed in the synapse mode to store the weight data, to obtain the results of multiplication and accumulation applied to the weight data and the input data. The analog compute module 101 can store the results in a further predefined region of memory addresses; and the results can be read from the further predefined region of memory addresses. Thus, the analog compute module 101 can be used in the computing system as an accelerator for multiplication and accumulation by writing data into predefined address regions and reading results from associated address regions.

Optionally, one of the memory devices 167, . . . , 187 configured with an analog compute module 101 is further configured to perform the computations of the network manager 102.

Optionally, the components 106, . . . , 108 can use the multiplication and accumulation capability of an analog compute module 101 in performing their computation tasks; and one of the components 106, . . . , 108 can be further configured to perform the computation of the network manager 102.

Optionally, the network manager 102 can be implemented via distributed computing implemented via the agents 161, . . . , 181 of the components 106, . . . , 108 and optionally the memory devices 167, . . . , 187.

Optionally, the analog compute module 101 can be further configured (e.g., via instructions) to perform the computation of an artificial neural network. For example, a component (e.g., 106 or 108 or the network manager 102) can write instructions for the computation of the artificial neural network to a predefined address region configured for instructions for computations of the artificial neural network, the weight data of the artificial neural network to a predefined address region configured for weight data, and input data to the artificial neural network to a predefined address region configured for input. The analog compute module 101 can execute the instructions to store the outputs of the artificial neural network to a predefined address region for output. Thus, the component (e.g., 106 or 108) in the computing system can use the analog compute module 101 as a co-processor for perform the computations of an artificial neural network.

FIG. 5 shows an analog compute module having a dynamic random access memory, a non-volatile memory cell array, and circuits to perform inference computations according to one embodiment.

For example, the analog compute module 101 in FIG. 2, FIG. 3, and FIG. 4 can be implemented as an integrated circuit device illustrated in FIG. 5.

In FIG. 5, the analog compute module 101 has an integrated circuit die 149 having logic circuits 151 and 153, an integrated circuit die 143 having the dynamic random access memory 105, and an integrated circuit die 145 having a non-volatile memory cell array 113.

The integrated circuit die 149 having logic circuits 151 and 153 can be considered a logic chip; the integrated circuit die 143 having the dynamic random access memory 105 can be considered a dynamic random access memory chip; and the integrated circuit die 145 having the memory cell array 113 can be considered a synapse memory chip.

In FIG. 5, the integrated circuit die 145 having the memory cell array 113 further includes voltage drivers 115 and current digitizers 117. The memory cell array 113 are connected such that currents generated by the memory cells in response to voltages applied by the voltage drivers 115 are summed in the array 113 for columns of memory cells (e.g., as illustrated in FIG. 8 and FIG. 9); and the summed currents are digitized to generate the sum of bit-wise multiplications. The inference logic circuit 153 can be configured to instruct the voltage drivers 115 to apply read voltages according to a column of inputs, perform shifts and summations to generate the results of a column or matrix of weights multiplied by the column of inputs with accumulation.

Optionally, the inference logic circuit 153 can include a programmable processor that can execute a set of instructions to control the inference computation. Alternatively, the inference computation is configured for a particular artificial neural network with certain aspects adjustable via weights stored in the memory cell array 113. Optionally, the inference logic circuit 153 is implemented via an application-specific integrated circuit (ASIC), a field-programmable gate array (FPGA), or a core of a programmable microprocessor.

In FIG. 5, the integrated circuit die 145 having the memory cell array 113 has a bottom surface 133; and the integrated circuit die 149 having the inference logic circuit 153 has a portion of a top surface 134. The two surfaces 133 and 134 can be connected via hybrid bonding to provide a portion of a direct bond interconnect 147 between the metal portions on the surfaces 133 and 134.

Direct bonding is a type of chemical bond between two surfaces of material meeting various requirements. Direct bonding of wafers typically includes pre-processing wafers, pre-bonding the wafers at room temperature, and annealing at elevated temperatures. For example, direct bonding can be used to join two wafers of a same material (e.g., silicon); anodic bonding can be used to join two wafers of different materials (e.g., silicon and borosilicate glass); eutectic bonding can be used to form a bonding layer of eutectic alloy based on silicon combining with metal to form a eutectic alloy.

Hybrid bonding can be used to join two surfaces having metal and dielectric material to form a dielectric bond with an embedded metal interconnect from the two surfaces. The hybrid bonding can be based on adhesives, direct bonding of a same dielectric material, anodic bonding of different dielectric materials, eutectic bonding, thermocompression bonding of materials, or other techniques, or any combination thereof.

Copper microbump is a traditional technique to connect dies at packaging level. Tiny metal bumps can be formed on dies as microbumps and connected for assembling into an integrated circuit package. It is difficult to use microbumps for high density connections at a small pitch (e.g., 10 micrometers). Hybrid bonding can be used to implement connections at such a small pitch not feasible via microbumps.

The integrated circuit die 143 having the dynamic random access memory 105 has a bottom surface 131; and the integrated circuit die 149 having the inference logic circuit 153 has another portion of its top surface 132. The two surfaces 131 and 132 can be connected via hybrid bonding to provide a portion of the direct bond interconnect 147 between the metal portions on the surfaces 131 and 132.

The integrated circuit die 149 can include a controller logic circuit 151 configured to control the operations of the analog compute module 101, such as a portion of the operations of a network manager 102 that uses the multiplication and accumulation function provided via the memory cell array 113.

In some implementations, the direct bond interconnect 147 includes wires for writing data from the dynamic random access memory 105 to a portion of the memory cell array 113 (e.g., for storing in a synapse mode or a storage mode).

The inference logic circuit 153 can buffer the result of inference computations in a portion of the dynamic random access memory 105.

In some implementations, a buffer is configured in the integrated circuit die 149.

The interface 155 of the analog compute module 101 can be configured to support a memory access protocol, or a storage access protocol, or both. Thus, an external device (e.g., a processor, a central processing unit) can send commands to the interface 155 to access the storage capacity provided by the dynamic random access memory 105 and the memory cell array 113.

For example, the interface 155 can be configured to support a connection and communication protocol on a computer bus, such as a compute express link, a memory bus, a peripheral component interconnect express (PCIe) bus, a serial advanced technology attachment (SATA) bus, a universal serial bus (USB) bus, etc. In some embodiments, the interface 155 can be configured to include an interface of a solid-state drive (SSD), such as a ball grid array (BGA) SSD. In some embodiments, the interface 155 is configured to include an interface of a memory module, such as a double data rate (DDR) memory module, a dual in-line memory module, etc. The interface 155 can be configured to support a communication protocol such as a protocol according to non-volatile memory express (NVMe), non-volatile memory host controller interface specification (NVMHCIS), etc.

The analog compute module 101 can appear to be a memory sub-system from the point of view of a device in communication with the interface 155. Through the interface 155 an external device (e.g., a processor, a central processing unit) can access the storage capacity of the dynamic random access memory 105 and the memory cell array 113. For example, the external device can store and update weight matrices and instructions for the inference logic circuit 153, retrieve results generated in the dynamic random access memory 105 by the logic circuits 151 and 153, etc.

In some implementations, some of the circuits (e.g., voltage drivers 115, or current digitizers 117, or both) are implemented in the integrated circuit die 149 having the inference logic circuit 153, as illustrated in FIG. 6.

In FIG. 5, the dynamic random access memory chip and the synapse memory chip are placed side by side on the same side (e.g., top side) of the logic chip. Alternatively, the dynamic random access memory chip and the synapse memory chip can be placed on different sides (e.g., top surface and bottom surface) of the logic chip, as illustrated in FIG. 7.

The analog compute module 101 can include an integrated circuit package 157 configured to enclose at least the integrated circuit dies 143, 145, and 149.

FIG. 6 and FIG. 7 illustrate different configurations of analog compute modules according to some embodiments.

Similar to the analog compute module 101 of FIG. 5, the analog compute modules 101 in FIG. 6 and FIG. 7 can also have an integrated circuit die 149 having logic circuits 151 and 153, an integrated circuit die 143 having a dynamic random access memory 105, and an integrated circuit die 145 having a memory cell array 113.

However, in FIG. 6, the voltage drivers 115 and current digitizers 117 are configured in the integrated circuit die 149 having the inference logic circuit 153. Thus, the integrated circuit die 145 of the memory cell array 113 can be manufactured to contain memory cells and wire connections without added complications of voltage drivers 115 and current digitizers 117.

In FIG. 6, a direct bond interconnect 148 connects the dynamic random access memory 105 to the controller logic circuit 151. Alternatively, microbumps can be used to connect the dynamic random access memory 105 to the controller logic circuit 151.

In FIG. 6, another direct bond interconnect 147 connects the memory cell array 113 to the voltage drivers 115 and the current digitizers 117. Since the direct bond interconnects 147 and 148 are separate from each other, the dynamic random access memory chip may not write data directly into the synapse memory chip without going through the logic circuits in the logic chip. Alternatively, a direct bond interconnect 147 as illustrated in FIG. 5 can be configured to allow the dynamic random access memory chip to write data directly into the synapse memory chip without going through the logic circuits in the logic chip.

Optionally, some of the voltage drivers 115, the current digitizers 117, and the inference logic circuits 153 can be configured in the synapse memory chip, while the remaining portion is configured in the logic chip.

FIG. 5 and FIG. 6 illustrate configurations where the synapse memory chip and the dynamic random access memory chip are placed side-by-side on the logic chip. During manufacturing of the analog compute modules 101, synapse memory chips and dynamic random access memory chips can be placed on a surface of a logic wafer containing the circuits of the logic chips to apply hybrid bonding. The synapse memory chips and dynamic random access memory chips can be combined to the logic wafer at the same time. Subsequently, the logic wafer having the attached synapse memory chips and dynamic random access memory chips can be divided into chips of the analog compute modules (e.g., 101).

Alternatively, as in FIG. 7, the dynamic random access memory chip and the synapse memory chip are placed on different sides of the logic chip.

In FIG. 7, the dynamic random access memory chip is connected to the logic chip via a direct bond interconnect 148 on the top surface 132 of the logic chip. Alternatively, microbumps can be used to connect the dynamic random access memory chip to the logic chip. The synapse memory chip is connected to the logic chip via a direct bond interconnect 147 on the bottom surface 133 of the logic chip. During the manufacturing of the analog compute modules 101, a dynamic random access memory wafer can be attached to, bonded to, or combined with the top surface of the logic wafer in a process/operation; and the memory wafer can be attached to, bonded to, or combined with the bottom side of the logic wafer in another process. The combined wafers can be divided into chips of the analog compute modules 101.

FIG. 7 illustrates a configuration in which the voltage drivers 115 and current digitizers 117 are configured in the synapse memory chip having the memory cell array 113. Alternatively, some of the voltage drivers 115, the current digitizers 117, and the inference logic circuit 153 are configured in the synapse memory chip, while the remaining portion is configured in the logic chip disposed between the dynamic random access memory chip and the synapse memory chip. In other implementations, the voltage drivers 115, the current digitizers 117, and the inference logic circuit 153 are configured in the logic chip, in a way similar to the configuration illustrated in FIG. 6.

In FIG. 5, FIG. 6, and FIG. 7, the interface 155 is positioned at the bottom side of the analog compute module 101, while the dynamic random access memory chip is positioned at the top side of the analog compute module 101.

The voltage drivers 115 in FIG. 5, FIG. 6, and FIG. 7 can be controlled to apply voltages to program the threshold voltages of memory cells in the array 113. Data stored in the memory cells can be represented by the levels of the programmed threshold voltages of the memory cells.

A typical memory cell in the array 113 has a nonlinear current to voltage curve. When the threshold voltage of the memory cell is programmed in a synapse mode to a first level to represent a stored value of one, the memory cell allows a predetermined amount of current to go through when a predetermined read voltage higher than the first level is applied to the memory cell. When the predetermined read voltage is not applied (e.g., the applied voltage is zero), the memory cell allows a negligible amount of current to go through, compared to the predetermined amount of current. On the other hand, when the threshold voltage of the memory cell is programmed in the synapse mode to a second level higher than the predetermined read voltage to represent a stored value of zero, the memory cell allows a negligible amount of current to go through, regardless of whether the predetermined read voltage is applied. Thus, when a bit of weight is stored in the memory as discussed above, and a bit of input is used to control whether to apply the predetermined read voltage, the amount of current going through the memory cell as a multiple of the predetermined amount of current corresponds to the digital result of the stored bit of weight multiplied by the bit of input. Currents representative of the results of 1-bit by 1-bit multiplications can be summed in an analog form before digitized for shifting and summing to perform multiplication and accumulation of multi-bit weights against multi-bit inputs, as further discussed below.

FIG. 8 shows the computation of a column of weight bits multiplied by a column of input bits to provide an accumulation result according to one embodiment.

In FIG. 8, a column of memory cells 207, 217, . . . , 227 (e.g., in the memory cell array 113 of an analog compute module 101) can be programmed in the synapse mode to have threshold voltages at levels representative of weights stored one bit per memory cell.

The column of memory cells 207, 217, . . . , 227, programmed in the synapse mode, can be read in a synapse mode, during which voltage drivers 203, 213, . . . , 223 (e.g., in the voltage drivers 115 of an analog compute module 101) are configured to apply voltages 205, 215, . . . , 225 concurrently to the memory cells 207, 217, . . . , 227 respectively according to their received input bits 201, 211, . . . , 221.

For example, when the input bit 201 has a value of one, the voltage driver 203 applies the predetermined read voltage as the voltage 205, causing the memory cell 207 to output the predetermined amount of current as its output current 209 if the memory cell 207 has a threshold voltage programmed at a lower level, which is lower than the predetermined read voltage, to represent a stored weight of one, or to output a negligible amount of current as its output current 209 if the memory cell 207 has a threshold voltage programmed at a higher level, which is higher than the predetermined read voltage, to represent a stored weight of zero. However, when the input bit 201 has a value of zero, the voltage driver 203 applies a voltage (e.g., zero) lower than the lower level of threshold voltage as the voltage 205 (e.g., does not apply the predetermined read voltage), causing the memory cell 207 to output a negligible amount of current at its output current 209 regardless of the weight stored in the memory cell 207. Thus, the output current 209 as a multiple of the predetermined amount of current is representative of the result of the weight bit, stored in the memory cell 207, multiplied by the input bit 201.

Similarly, the current 219 going through the memory cell 217 as a multiple of the predetermined amount of current is representative of the result of the weight bit, stored in the memory cell 217, multiplied by the input bit 211; and the current 229 going through the memory cell 227 as a multiple of the predetermined amount of current is representative of the result of the weight bit, stored in the memory cell 227, multiplied by the input bit 221.

The output currents 209, 219, . . . , and 229 of the memory cells 207, 217, . . . , 227 are connected to a common line 241 (e.g., bitline) for summation. The summed current 231 is compared to the unit current 232, which is equal to the predetermined amount of current, by a digitizer 233 of an analog to digital converter 245 to determine the digital result 237 of the column of weight bits, stored in the memory cells 207, 217, . . . , 227 respectively, multiplied by the column of input bits 201, 211, . . . , 221 respectively with the summation of the results of multiplications.

The sum of negligible amounts of currents from memory cells connected to the line 241 is small when compared to the unit current 232 (e.g., the predetermined amount of current). Thus, the presence of the negligible amounts of currents from memory cells does not alter the result 237 and is negligible in the operation of the analog to digital converter 245.

In FIG. 8, the voltages 205, 215, . . . , 225 applied to the memory cells 207, 217, . . . , 227 are representative of digitized input bits 201, 211, . . . , 221; the memory cells 207, 217, . . . , 227 are programmed to store digitized weight bits; and the currents 209, 219, . . . , 229 are representative of digitized results. Thus, the memory cells 207, 217, . . . , 227 do not function as memristors that convert analog voltages to analog currents based on their linear resistances over a voltage range; and the operating principle of the memory cells in computing the multiplication is fundamentally different from the operating principle of a memristor crossbar. When a memristor crossbar is used, conventional digital to analog converters are used to generate an input voltage proportional to inputs to be applied to the rows of memristor crossbar. When the technique of FIG. 8 is used, such digital to analog converters can be eliminated; and the operation of the digitizer 233 to generate the result 237 can be greatly simplified. The result 237 is an integer that is no larger than the count of memory cells 207, 217, . . . , 227 connected to the line 241. The digitized form of the output currents 209, 219, . . . , 229 can increase the accuracy and reliability of the computation implemented using the memory cells 207, 217, . . . , 227.

In general, a weight involving a multiplication and accumulation operation can be more than one bit. Multiple columns of memory cells can be used to store the different significant bits of weights, as illustrated in FIG. 9 to perform multiplication and accumulation operations.

The circuit illustrated in FIG. 8 can be considered a multiplier-accumulator unit configured to operate on a column of 1-bit weights and a column of 1-bit inputs. Multiple such circuits can be connected in parallel to implement a multiplier-accumulator unit to operate on a column of multi-bit weights and a column of 1-bit inputs, as illustrated in FIG. 9.

The circuit illustrated in FIG. 8 can also be used to read the data stored in the memory cells 207, 217, . . . , 227. For example, to read the data or weight stored in the memory cell 207, the input bits 211, . . . , 221 can be set to zero to cause the memory cells 217, . . . , 227 to output negligible amount of currents into the line 241 (e.g., as a bitline). The input bit 201 is set to one to cause the voltage driver 203 to apply the predetermined read voltage. Thus, the result 237 from the digitizer 233 provides the data or weight stored in the memory cell 207. Similarly, the data or weight stored in the memory cell 217 can be read via applying one as the input bit 211 and zeros as the remaining input bits in the column; and data or weight stored in the memory cell 227 can be read via applying one as the input bit 221 and zeros as the other input bits in the column.

In general, the circuit illustrated in FIG. 8 can be used to select any of the memory cells 207, 217, . . . , 227 for read or write. A voltage driver (e.g., 203) can apply a programming voltage pulse to adjust the threshold voltage of a respective memory cell (e.g., 207) to erase data, to store data or weigh, etc.

FIG. 9 shows the computation of a column of multi-bit weights multiplied by a column of input bits to provide an accumulation result according to one embodiment.

In FIG. 9, a weight 250 in a binary form has a most significant bit 257, a second most significant bit 258, . . . , a least significant bit 259. The significant bits 257, 258, . . . , 259 can be stored in a rows of memory cells 207, 206, . . . , 208 (e.g., in the memory cell array 113 of an analog compute module 101) across a number of columns respectively in an array 273. The significant bits 257, 258, . . . , 259 of the weight 250 are to be multiplied by the input bit 201 represented by the voltage 205 applied on a line 281 (e.g., a wordline) by a voltage driver 203 (e.g., as in FIG. 8).

Similarly, memory cells 217, 216, . . . , 218 can be used to store the corresponding significant bits of a next weight to be multiplied by a next input bit 211 represented by the voltage 215 applied on a line 282 (e.g., a wordline) by a voltage driver 213 (e.g., as in FIG. 8); and memory cells 227, 226, . . . , 228 can be used to store corresponding of a weight to be multiplied by the input bit 221 represented by the voltage 225 applied on a line 283 (e.g., a wordline) by a voltage driver 223 (e.g., as in FIG. 8).

The most significant bits (e.g., 257) of the weights (e.g., 250) stored in the respective rows of memory cells in the array 273 are multiplied by the input bits 201, 211, . . . , 221 represented by the voltages 205, 215, . . . , 225 and then summed as the current 231 in a line 241 and digitized using a digitizer 233, as in FIG. 8, to generate a result 237 corresponding to the most significant bits of the weights.

Similarly, the second most significant bits (e.g., 258) of the weights (e.g., 250) stored in the respective rows of memory cells in the array 273 are multiplied by the input bits 201, 211, . . . , 221 represented by the voltages 205, 215, . . . , 225 and then summed as a current in a line 242 and digitized to generate a result 236 corresponding to the second most significant bits.

Similarly, the least most significant bits (e.g., 259) of the weights (e.g., 250) stored in the respective rows of memory cells in the array 273 are multiplied by the input bits 201, 211, . . . , 221 represented by the voltages 205, 215, . . . , 225 and then summed as a current in a line 243 and digitized to generate a result 238 corresponding to the least significant bit.

The most significant bit can be left shifted by one bit to have the same weight as the second significant bit, which can be further left shifted by one bit to have the same weight as the next significant bit. Thus, the result 237 generated from multiplication and summation of the most significant bits (e.g., 257) of the weights (e.g., 250) can be applied an operation of left shift 247 by one bit; and the operation of add 246 can be applied to the result of the operation of left shift 247 and the result 236 generated from multiplication and summation of the second most significant bits (e.g., 258) of the weights (e.g., 250). The operations of left shift (e.g., 247, 249) can be used to apply weights of the bits (e.g., 257, 258, . . . ) for summation using the operations of add (e.g., 246, . . . , 248) to generate a result 251. Thus, the result 251 is equal to the column of weights in the array 273 of memory cells multiplied by the column of input bits 201, 211, . . . , 221 with multiplication results accumulated.

In general, an input involving a multiplication and accumulation operation can be more than 1 bit. Columns of input bits can be applied one column at a time to the weights stored in the array 273 of memory cells to obtain the result of a column of weights multiplied by a column of inputs with results accumulated as illustrated in FIG. 10.

The circuit illustrated in FIG. 9 can be used to read the data stored in the array 273 of memory cells. For example, to read the data or weight 250 stored in the memory cells 207, 206, . . . , 208, the input bits 211, . . . , 221 can be set to zero to cause the memory cells 217, 216, . . . , 218, . . . , 227, 226, . . . , 228 to output negligible amount of currents into the line 241, 242, . . . , 243 (e.g., as bitlines). The input bit 201 is set to one to cause the voltage driver 203 to apply the predetermined read voltage as the voltage 205. Thus, the results 237, 236, . . . , 238 from the digitizers (e.g., 233) connected to the lines 241, 242, . . . , 243 provide the bits 257, 258, . . . , 259 of the data or weight 250 stored in the row of memory cells 207, 206, . . . , 208. Further, the result 251 computed from the operations of shift 247, 249, . . . and operations of add 246, . . . , 248 provides the weight 250 in a binary form.

In general, the circuit illustrated in FIG. 9 can be used to select any row of the memory cell array 273 for read. Optionally, different columns of the memory cell array 273 can be driven by different voltage drivers. Thus, the memory cells (e.g., 207, 206, . . . , 208) in a row can be programmed to write data in parallel (e.g., to store the bits 257, 258, . . . , 259) of the weight 250.

FIG. 10 shows the computation of a column of multi-bit weights multiplied by a column of multi-bit inputs to provide an accumulation result according to one embodiment.

In FIG. 10, the significant bits of inputs (e.g., 280) are applied to a multiplier-accumulator unit 270 at a plurality of time instances T, T1, . . . , T2.

For example, a multi-bit input 280 can have a most significant bit 201, a second most significant bit 202, . . . , a least significant bit 204.

At time T, the most significant bits 201, 211, . . . , 221 of the inputs (e.g., 280) are applied to the multiplier-accumulator unit 270 to obtain a result 251 of weights (e.g., 250), stored in the memory cell array 273, multiplied by the column of bits 201, 211, . . . , 221 with summation of the multiplication results.

For example, the multiplier-accumulator unit 270 can be implemented in a way as illustrated in FIG. 9. The multiplier-accumulator unit 270 has voltage drivers 271 connected to apply voltages 205, 215, . . . , 225 representative of the input bits 201, 211, . . . , 221. The multiplier-accumulator unit 270 has a memory cell array 273 storing bits of weights as in FIG. 9. The multiplier-accumulator unit 270 has digitizers 275 to convert currents summed on lines 241, 242, . . . , 243 for columns of memory cells in the array 273 to output results 237, 236, . . . , 238. The multiplier-accumulator unit 270 has shifters 277 and adders 279 connected to combine the column result 237, 236, . . . , 238 to provide a result 251 as in FIG. 9. In some implementations, the logic circuits of the multiplier-accumulator unit 270 (e.g., shifters 277 and adders 279) are implemented as part of the inference logic circuit 153.

Similarly, at time T1, the second most significant bits 202, 212, . . . , 222 of the inputs (e.g., 280) are applied to the multiplier-accumulator unit 270 to obtain a result 253 of weights (e.g., 250) stored in the memory cell array 273 and multiplied by the vector of bits 202, 212, . . . , 222 with summation of the multiplication results.

Similarly, at time T2, the least significant bits 204, 214, . . . , 224 of the inputs (e.g., 280) are applied to the multiplier-accumulator unit 270 to obtain a result 255 of weights (e.g., 250), stored in the memory cell array 273, multiplied by the vector of bits 202, 212, . . . , 222 with summation of the multiplication results.

The result 251 generated from multiplication and summation of the most significant bits 201, 211, . . . , 221 of the inputs (e.g., 280) can be applied an operation of left shift 261 by one bit; and the operation of add 262 can be applied to the result of the operation of left shift 261 and the result 253 generated from multiplication and summation of the second most significant bits 202, 212, . . . , 222 of the inputs (e.g., 280).

The operations of left shift (e.g., 261, 263) can be used to apply weights of the bits (e.g., 201, 202, . . . ) for summation using the operations of add (e.g., 262, . . . , 264) to generate a result 267. Thus, the result 267 is equal to the weights (e.g., 250) in the array 273 of memory cells multiplied by the column of inputs (e.g., 280) respectively and then summed.

A plurality of multiplier-accumulator unit 270 can be connected in parallel to operate on a matrix of weights multiplied by a column of multi-bit inputs over a series of time instances T, T1, . . . , T2.

The multiplier-accumulator units (e.g., 270) illustrated in FIG. 8, FIG. 9, and FIG. 10 can be implemented in analog compute modules 101 in FIG. 1, FIG. 5, FIG. 6, and FIG. 7.

In some implementations, the memory cell array 113 in the analog compute modules 101 in FIG. 1, FIG. 5, FIG. 6, and FIG. 7 has multiple layers of memory cell arrays.

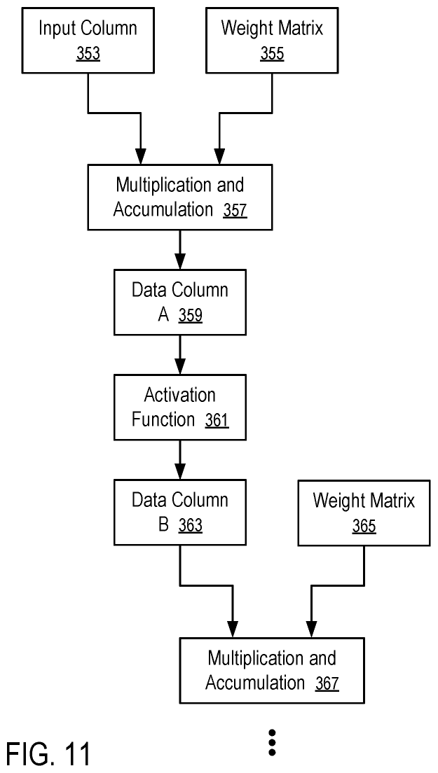

FIG. 11 shows an implementation of artificial neural network computations according to one embodiment.

For example, the computations of FIG. 11 can be implemented in the analog compute modules 101 of FIG. 1, FIG. 5, FIG. 6, and FIG. 7.

In FIG. 11, a weight matrix 355 is stored in one or more layers of the memory cell array 113 in the synapse memory chip of the analog compute module 101.

A multiplication and accumulation 357 combines an input column 353 and the weight matrix 355 to generate a data column 359. For example, according to instructions stored in the analog compute module 101, the inference logic circuit 153 identifies the storage location of the weight matrix 355 in the synapse memory chip, instructs the voltage drivers 115 to apply, according to the bits of the input column 353, voltages to memory cells storing the weights in the matrix 355 in the synapse mode, and retrieve the multiplication and accumulation results (e.g., 267) from the logic circuits (e.g., adder 264) of the multiplier-accumulator units 270 containing the memory cells.

The multiplication and accumulation results (e.g., 267) provide a column 359 of data representative of combined inputs to a set of input artificial neurons of the artificial neural network. The inference logic circuit 153 can use an activation function 361 to transform the data column 359 to a column 363 of data representative of outputs from the set of input artificial neurons. The outputs from the set of artificial neurons can be provided as inputs to a next set of artificial neurons. A weight matrix 365 includes weights applied to the outputs of the neurons as inputs to the next set of artificial neurons and biases for the neurons. A multiplication and accumulation 367 can be performed in a similar way as the multiplication and accumulation 357. Such operations can be repeated from multiple set of artificial neurons to generate an output of the artificial neural network.

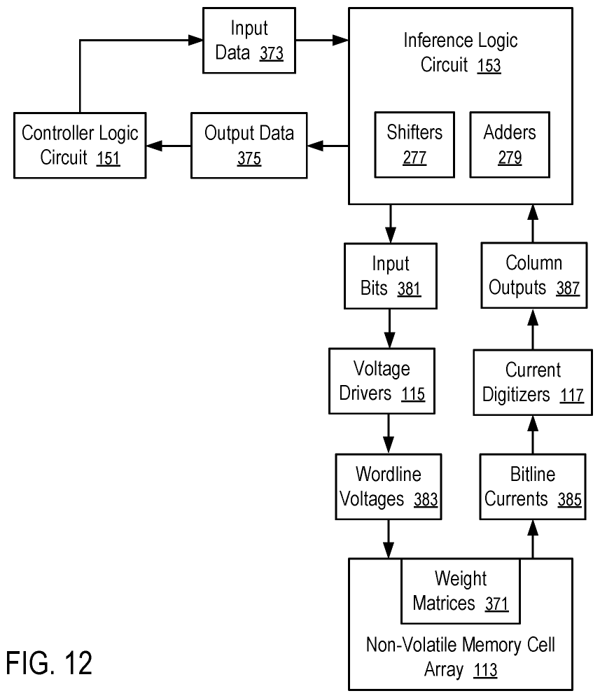

FIG. 12 shows a controller logic circuit using an inference logic circuit in multiplication and accumulation computation according to one embodiment. For example, the technique of FIG. 12 can be implemented in analog compute modules 101 of FIG. 1, FIG. 5, FIG. 6, and FIG. 7.

In FIG. 12, a controller logic circuit 151 in a logic chip (e.g., integrated circuit die 149) in an analog compute module 101 is configured to provide a service of multiplication and accumulation (e.g., to a processor outside of the analog compute module 101).

In response to receiving input data 373 written into an address region associated with the weight matrices 371, the controller logic circuit 151 can request the inference logic circuit 153 to apply the input data 373 to the weight matrices 371 to generate output data 375 resulting from multiplication and accumulation. The controller logic circuit 151 can store the output data 375 in an address region configured to be read by the processor outside of the analog compute module 101 to the retrieval of the output data 375.

In some implementations, the input data 373 can include an identification of the location of a matrix 371 stored in the synapse mode in the memory cell array 113 and a column of inputs (e.g., 280). In response, the inference logic circuit 153 uses a column of input bits 381 to control voltage drivers 115 to apply wordline voltages 383 onto rows of memory cells storing the weights of a matrix 371 identified by the input data 373. The voltage drivers 115 apply voltages of predetermined magnitudes on wordlines to represent the input bits 381. The memory cells in the memory cell array 113 are configured to output currents that are negligible or multiples of a predetermined amount of current 232. Thus, the combination of the voltage drivers 115 and the memory cells storing the weight matrices 371 functions as digital to analog converters configured to convert the results of bits of weights (e.g., 250) multiplied by the bits of inputs (e.g., 280) into output currents (e.g., 209, 219, . . . , 229). Bitlines (e.g., lines 241, 242, . . . , 243) in the memory cell array 113 sum the currents in an analog form. The summed currents (e.g., 231) in the bitlines (e.g., line 241) are digitized as column outputs 387 by the current digitizers 117 for further processing in a digital form (e.g., using shifters 277 and adders 279 in the inference logic circuit 153) to obtain the output data 375.

As illustrated in FIG. 8 and FIG. 9, the wordline voltages 383 (e.g., 205, 215, . . . , 225) are representative of the applied input bits 381 (e.g., 201, 211, . . . , 221) and cause the memory cells in the array 113 to generate output currents (e.g., 209, 21, . . . , 229). The memory cell array 113 connects output currents from each column of memory cells to a respective line (e.g., 241, 242, . . . , or 243) to sum the output currents for a respective column. Current digitizers 117 can determine the bitline currents 385 in the lines (e.g., bitlines) in the array 113 as multiples of a predetermined amount of current 232 to provide the summation results (e.g., 237, 236, . . . , 238) as the column outputs 387. Shifters 277 and adders 279 of the inference logic circuit 153 (or in the synapse memory chip) can be used to combine the column outputs 387 with corresponding weights for different significant bits of weights (e.g., 250) as in FIG. 9 and with corresponding weights (e.g., 250) for the different significant bits of the inputs (e.g., 280) as in FIG. 10 to generate results of multiplication and accumulation.

The inference logic circuit 153 can provide the results of multiplication and accumulation as the output data 375. In response, the controller logic circuit 151 can provide further input data 373 to obtain further output data 375 by combining the input data 373 with a weight matrix 371 in the memory cell array 113 through operations of multiplication and accumulation.

The memory cell array 113 stores the weight matrices 371 of an artificial neural network, such as weight matrices 173, etc. The controller logic circuit 151 can be configured (e.g., via instructions) to apply inputs to one set of artificial neurons at a time, as in FIG. 11, to perform the computations of the artificial neural network. Thus, the computation of the artificial neural network can be performed within the analog compute module 101 (e.g., to implement a network manager 102) without assistance from the processor outside of the analog compute module 101.

Alternatively, the analog compute module 101 is configured to perform the operations of multiplication and accumulation (e.g., 357, 367) in response to the processor writing the inputs (e.g., columns 353, 363) into the analog compute module 101; and the processor can be configured to retrieve the results of the multiplication and accumulation (e.g., data column 359) and apply the computations of activation function 361 and other computations of the artificial neural network.

Thus, the controller logic circuit 151 can be configured to function as an accelerator of multiplication and accumulation, or a co-processor of artificial neural networks, or both.

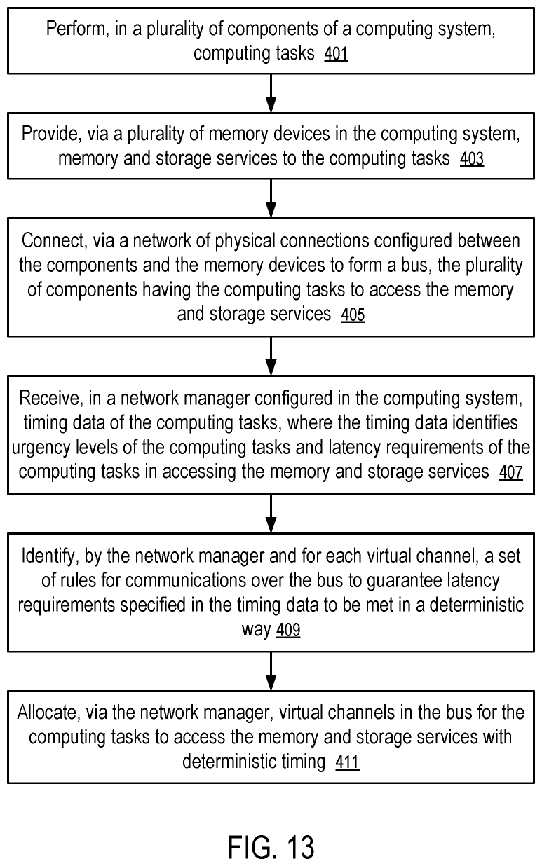

FIG. 13 shows a method of managing a time sensitive networking bus according to one embodiment. For example, the method of FIG. 13 can be performed in a network manager 102 of FIG. 1, using an analog compute module 101 of FIG. 5, FIG. 6, and FIG. 7 with the multiplication and accumulation techniques of FIG. 8, FIG. 9, and FIG. 10, and optionally the artificial neural network computations illustrated in FIG. 12.

At block 401, a plurality of components 106, . . . , 108 of a computing system (e.g., as in FIG. 1) perform computing tasks (e.g., via running applications 165, . . . , 185).

For example, the computing system as illustrated in FIG. 1 has components 106, . . . , 108 and a plurality of memory devices 167, . . . , 187 interconnected via a bus 104 in logic. The bus 104 is implemented via a plurality of physical connections having a topology of a network. The computing system has a network manager 102 configured to specify rules for communications in the bus 104 such that the timings (e.g., delays, latency) in communications through a virtual channel in the bus 104 is deterministic. The network of physical connections can optionally include redundant connections, switches, hubs, etc. Different virtual channels can be configured to have different timing behaviors. Thus, the bus 104 can be a time sensitive networking bus 104.

Optionally, the network manager 102 can be implemented as a standalone, dedicated device (independent of the components 106, . . . , 108 and the memory devices 167, . . . , 187) that is connected to the bus 104 to manage the allocation of virtual channels for the computing tasks. Alternatively, the network manager 102 can be implemented using one of the memory devices (e.g., 167 or 187) that also provides memory and storage services to the components 106, . . . , 108. Alternatively, the network manager 102 can be implemented using one of the components (e.g., 106 or 108) that also runs one or more applications (e.g., 165 or 185) to perform computations not related to virtual channel allocation. Alternatively, at least some of the components 106, . . . , 108 and the memory devices 167, . . . , 187 can cooperate with each other to implement the function of the network manager 102.

At block 403, a plurality of memory devices 167, . . . , 187 in the computing system provides memory and storage services to the computing tasks. The memory and storage services can include cache services and buffer services. Some of the memory and storage services can be optionally reconfigured to be hosted on different memory devices 167, . . . , 187, or different combinations of memory devices 167, . . . , 187.

At block 405, a network of physical connections configured between the components 106, . . . , 108 and the memory devices 167, . . . , 187 to form a bus 108 connects the plurality of components 106, . . . , 108 having the computing tasks to access the memory and storage services.

For example, a physical connection in the bus 108 can be in accordance with computer express link (CXL), peripheral component interconnect express (PCIe), ethernet, or other communications standards.

At block 407, a network manager 102 configured in the computing system receives timing data 163, . . . , 183 of the computing tasks, where the timing data 163, . . . , 183 identifies urgency levels 162, . . . , 182 of the computing tasks (e.g., applications 165, . . . , 185) and latency requirements (e.g., 164, . . . , 184) of the computing tasks in accessing the memory and storage services.

Optionally, the network manager 102 can predict (e.g., using an artificial neural network or a predictive model) some aspects of the timing data 163, . . . , 183.

For example, the artificial neural network or the predictive model can be trained using the activity records of the computing system in a past period of time to predict the activities of the components 106, . . . , 108, such as when a computing task of an application (e.g., 185) will start, the urgency level (e.g., 182) of the computing task, the latency requirements 184 of the task, the bandwidth requirements of the computing task in accessing the memory and storage services over the bus 104, etc. The predictions can be used to plan and prepare resources for the allocation of a virtual channel for the computing task (or the adjustment of the allocated virtual channel for an ongoing computing task).

Optionally, the network manager 102 can communicate with agents 161, . . . , 181 in the components 106, . . . , 108 to negotiate and adjust certain aspects of the timing data 163, . . . , 183 for an improved overall performance level of the computing system.

At block 409, the network manager 102 identifies, for each virtual channel, a set of rules for communications over the bus 104 to guarantee latency requirements 164, . . . , 184 specified in the timing data 163, . . . , 183 (and other timing requirements) to be met in a deterministic way.

At block 411, the network manager 102 allocates virtual channels 168, . . . , 188 in the bus 104 for the computing tasks (e.g., applications 165, . . . , 185) to access the memory and storage services with deterministic timing.

For example, the network manager 102 can be configured to adjust a first virtual channel 168 for a first computing task (e.g., application 165 running in the component 106) having a first urgency level (e.g., 162), in allocation of a second virtual channel (e.g., 188) for a second computing task (e.g., application 185) having a second urgency level (e.g., 182) higher than the first urgency level (e.g., 162). When the available resources over the bus 104 to access the memory and storage services provided in the memory devices 167, . . . , 187 are insufficient for the allocation of the second virtual channel (e.g., 188), the network manager 102 can perform inference computations to identify one or more changes to virtual channel allocations to accommodate the allocation of the second virtual channel (e.g., 188) that has a high urgency level (e.g., 182).

For example, the network manager 102 can be configured to adjust the first virtual channel (e.g., 168) via at least: a change of a host of data (e.g., 169) of the first computing task (e.g., application 165) from a first memory device (e.g., 167) to a second memory device (e.g., 187); a change of a host of the first computing task (e.g., application 165) from a first component (e.g., 106) to a second component (e.g., 108); a change of a timing requirement (e.g., latency requirement 164) of the first virtual channel (e.g., 168); or a pause of usages of the first virtual channel (e.g., 168) by the first computing task (e.g., application 165); or any combination thereof.

For example, the network manager 102 includes an analog compute module 101 configured to perform at least a portion of the inference computations (e.g., in identifying the changes) in an analog form.

For example, the analog compute module 101 can be configured as an integrated circuit device having a non-volatile memory cell array 113. Memory cells in the array 113 can be programmed in a first mode (e.g., a synapse mode) according to weight matrices 173 of an artificial neural network trained to perform at least the portion of the inference computations. For example, the artificial neural network can be trained to predict an aspect of the timing data (e.g., 183) based on which the second virtual channel (e.g., 188) is allocated or reserved for a computing task (e.g., application 185) having a high urgency level (e.g., 182).

For example, each respective memory cell (e.g., 207) programmed in the first mode (e.g., synapse mode) in the non-volatile memory cell array 113 is configured to output: a predetermined amount of current (e.g., 232) in response to a predetermined read voltage when the respective memory cell (e.g., 207) has a threshold voltage programmed to represent a value of one; or a negligible amount of current in response to the predetermined read voltage when the threshold voltage is programmed to represent a value of zero. Each respective memory cell (e.g., 207) is programmable in a second mode (e.g., storage mode) in the non-volatile memory cell array 113 to have a threshold voltage positioned in one of a plurality of voltage regions, each representative of one of a plurality of predetermined values.

For example, the analog compute module 101 can include voltage drivers 115 and current digitizers 117 configured on a same integrated circuit die 145 of the non-volatile memory cell array 113 (e.g., as in FIG. 5 and FIG. 7) or another integrated circuit die 149 having an inference logic circuit 153 (e.g., as in FIG. 6). The non-volatile memory cell array 113 includes wordlines (e.g., 281, 282, . . . , 283) and bitlines (e.g., 241, 242, . . . , 243). The inference logic circuit 153 of the analog compute module 101 is configured to instruct the voltage drivers 115 to apply voltages to the wordlines (e.g., 281, 282, . . . , 283) according to input bits (e.g., 201, 211, . . . , 221) to cause output currents (e.g., 209, 219, . . . , 229) through memory cells (e.g., 207, 217, . . . , 227), programmed in the first mode (e.g., synapse mode) to store a weight matrix (e.g., 355 or 365), to be summed in the bitlines (e.g., 241) in an analog form. The current digitizers (e.g., 233) are configured to convert currents in the bitlines (e.g., 241, 242, . . . , 243) as multiple of the predetermined amount of current (e.g., 232), representative of digital results (e.g., 237, 236, . . . , 238) of multiplication and accumulation applied to the input bits (e.g., 201, 211, . . . , 221) and the weight matrix (e.g., 355 or 365).

For example, the inference logic circuit 153 of the analog compute module 101 can be configured to cause a voltage driver 203 to apply, to a respective wordline (e.g., 281): the predetermined read voltage, when an input bit (e.g., 205) provided for the respective wordline is one; or a voltage lower than the predetermined read voltage to cause memory cells (e.g., 207, 206, . . . , 208) on the respective wordline (e.g., 281) to output negligible amount of currents to the bitlines (e.g., 241, 242, . . . , 243), when the input bit (e.g., 201) provided for the respective wordline is zero.

Analog compute modules 101 (e.g., as in FIG. 1, FIG. 5, FIG. 6, and FIG. 7) can be configured as a storage device, a memory module, or a hybrid of a storage device and memory module. Examples of a storage device include a solid-state drive (SSD), a flash drive, a universal serial bus (USB) flash drive, an embedded multi-media controller (eMMC) drive, a universal flash storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The analog compute modules 101 (e.g., as in FIG. 1, FIG. 5, FIG. 6, and FIG. 7) can be installed in a computing system as a memory sub-system having an inference computation capability. Such a computing system can be a computing device such as a desktop computer, a laptop computer, a network server, a mobile device, a portion of a vehicle (e.g., airplane, drone, train, automobile, or other conveyance), an internet of things (IoT) enabled device, an embedded computer (e.g., one included in a vehicle, industrial equipment, or a networked commercial device), or such a computing device that includes memory and a processing device.

In general, a computing system can include a host system that is coupled to one or more memory sub-systems (e.g., analog compute module 101 of FIG. 1, FIG. 5, FIG. 6, and FIG. 7). In one example, a host system is coupled to one memory sub-system. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

For example, the host system can include a processor chipset (e.g., processing device) and a software stack executed by the processor chipset. The processor chipset can include one or more cores, one or more caches, a memory controller (e.g., NVDIMM controller), and a storage protocol controller (e.g., PCIe controller, SATA controller). The host system uses the memory sub-system, for example, to write data to the memory sub-system and read data from the memory sub-system.

The host system can be coupled to the memory sub-system via a physical host interface. Examples of a physical host interface include, but are not limited to, a serial advanced technology attachment (SATA) interface, a peripheral component interconnect express (PCIe) interface, a universal serial bus (USB) interface, a fibre channel, a serial attached SCSI (SAS) interface, a double data rate (DDR) memory bus interface, a small computer system interface (SCSI), a dual in-line memory module (DIMM) interface (e.g., DIMM socket interface that supports double data rate (DDR)), an open NAND flash interface (ONFI), a double data rate (DDR) interface, a low power double data rate (LPDDR) interface, a compute express link (CXL) interface, or any other interface. The physical host interface can be used to transmit data between the host system and the memory sub-system. The host system can further utilize an NVM express (NVMe) interface to access components (e.g., memory devices) when the memory sub-system is coupled with the host system by the PCIe interface. The physical host interface can provide an interface for passing control, address, data, and other signals between the memory sub-system and the host system. In general, the host system can access multiple memory sub-systems via a same communication connection, multiple separate communication connections, or a combination of communication connections.

The processing device of the host system can be, for example, a microprocessor, a central processing unit (CPU), a processing core of a processor, an execution unit, etc. In some instances, the controller can be referred to as a memory controller, a memory management unit, or an initiator. In one example, the controller controls the communications over a bus coupled between the host system and the memory sub-system. In general, the controller can send commands or requests to the memory sub-system for desired access to memory devices. The controller can further include interface circuitry to communicate with the memory sub-system. The interface circuitry can convert responses received from the memory sub-system into information for the host system.

The controller of the host system can communicate with the controller of the memory sub-system to perform operations such as reading data, writing data, or erasing data at the memory devices, and other such operations. In some instances, the controller is integrated within the same package of the processing device. In other instances, the controller is separate from the package of the processing device. The controller or the processing device can include hardware such as one or more integrated circuits (ICs), discrete components, a buffer memory, or a cache memory, or a combination thereof. The controller or the processing device can be a microcontroller, special-purpose logic circuitry (e.g., a field programmable gate array (FPGA), an application specific integrated circuit (ASIC), etc.), or another suitable processor.

The memory devices can include any combination of the different types of non-volatile memory components and volatile memory components. The volatile memory devices can be, but are not limited to, random access memory (RAM), such as dynamic random access memory (DRAM) and synchronous dynamic random access memory (SDRAM).

Some examples of non-volatile memory components include a negative-and (or, NOT AND) (NAND) type flash memory and write-in-place memory, such as three-dimensional cross-point (“3D cross-point”) memory. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells, or any combination thereof. The memory cells of the memory devices can be grouped as pages that can refer to a logical unit of the memory device used to store data. With some types of memory (e.g., NAND), pages can be grouped to form blocks.

Although non-volatile memory devices such as 3D cross-point type and NAND type memory (e.g., 2D NAND, 3D NAND) are described, the memory device can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), spin transfer torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory sub-system controller (or controller for simplicity) can communicate with the memory devices to perform operations such as reading data, writing data, or erasing data at the memory devices and other such operations (e.g., in response to commands scheduled on a command bus by controller). The controller can include hardware such as one or more integrated circuits (ICs), discrete components, or a buffer memory, or a combination thereof. The hardware can include digital circuitry with dedicated (i.e., hard-coded) logic to perform the operations described herein. The controller can be a microcontroller, special-purpose logic circuitry (e.g., a field programmable gate array (FPGA), an application specific integrated circuit (ASIC), etc.), or another suitable processor.

The controller can include a processing device (processor) configured to execute instructions stored in a local memory. In the illustrated example, the local memory of the controller includes an embedded memory configured to store instructions for performing various processes, operations, logic flows, and routines that control operation of the memory sub-system, including handling communications between the memory sub-system and the host system.

In some embodiments, the local memory can include memory registers storing memory pointers, fetched data, etc. The local memory can also include read-only memory (ROM) for storing micro-code. While the example memory sub-system includes a controller, in another embodiment of the present disclosure, a memory sub-system does not include a controller, and can instead rely upon external control (e.g., provided by an external host, or by a processor or controller separate from the memory sub-system).

In general, the controller can receive commands or operations from the host system and can convert the commands or operations into instructions or appropriate commands to achieve the desired access to the memory devices. The controller can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices. The controller can further include host interface circuitry to communicate with the host system via the physical host interface. The host interface circuitry can convert the commands received from the host system into command instructions to access the memory devices as well as convert responses associated with the memory devices into information for the host system.

The memory sub-system can also include additional circuitry or components that are not illustrated. In some embodiments, the memory sub-system can include a cache or buffer (e.g., DRAM) and address circuitry (e.g., a row decoder and a column decoder) that can receive an address from the controller and decode the address to access the memory devices.

In some embodiments, the memory devices include local media controllers that operate in conjunction with the memory sub-system controller to execute operations on one or more memory cells of the memory devices. An external controller (e.g., memory sub-system controller) can externally manage the memory device (e.g., perform media management operations on the memory device). In some embodiments, a memory device is a managed memory device, which is a raw memory device combined with a local media controller for media management within the same memory device package. An example of a managed memory device is a managed NAND (MNAND) device.

The controller or a memory device can include a storage manager configured to implement storage functions discussed above. In some embodiments, the controller in the memory sub-system includes at least a portion of the storage manager. In other embodiments, or in combination, the controller or the processing device in the host system includes at least a portion of the storage manager. For example, the controller, the controller, or the processing device can include logic circuitry implementing the storage manager. For example, the controller, or the processing device (processor) of the host system, can be configured to execute instructions stored in memory for performing the operations of the storage manager described herein. In some embodiments, the storage manager is implemented in an integrated circuit chip disposed in the memory sub-system. In other embodiments, the storage manager can be part of firmware of the memory sub-system, an operating system of the host system, a device driver, or an application, or any combination therein.

In one embodiment, an example machine of a computer system within which a set of instructions, for causing the machine to perform any one or more of the methods discussed herein, can be executed. In some embodiments, the computer system can correspond to a host system that includes, is coupled to, or utilizes a memory sub-system or can be used to perform the operations described above. In alternative embodiments, the machine can be connected (e.g., networked) to other machines in a LAN, an intranet, an extranet, or the internet, or any combination thereof. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a personal digital assistant (PDA), a cellular telephone, a web appliance, a server, a network router, a switch or bridge, a network-attached storage facility, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system includes a processing device, a main memory (e.g., read-only memory (ROM), flash memory, dynamic random access memory (DRAM) such as synchronous DRAM (SDRAM) or Rambus DRAM (RDRAM), static random access memory (SRAM), etc.), and a data storage system, which communicate with each other via a bus (which can include multiple buses).

Processing device represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device can also be one or more special-purpose processing devices such as an application specific integrated circuit (ASIC), a field programmable gate array (FPGA), a digital signal processor (DSP), network processor, or the like. The processing device is configured to execute instructions for performing the operations and steps discussed herein. The computer system can further include a network interface device to communicate over the network.

The data storage system can include a machine-readable medium (also known as a computer-readable medium) on which is stored one or more sets of instructions or software embodying any one or more of the methodologies or functions described herein. The instructions can also reside, completely or at least partially, within the main memory and within the processing device during execution thereof by the computer system, the main memory and the processing device also constituting machine-readable storage media. The machine-readable medium, data storage system, or main memory can correspond to the memory sub-system.

In one embodiment, the instructions include instructions to implement functionality corresponding to the operations described above. While the machine-readable medium is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In this description, various functions and operations are described as being performed by or caused by computer instructions to simplify description. However, those skilled in the art will recognize what is meant by such expressions is that the functions result from execution of the computer instructions by one or more controllers or processors, such as a microprocessor. Alternatively, or in combination, the functions and operations can be implemented using special-purpose circuitry, with or without software instructions, such as using application-specific integrated circuit (ASIC) or field-programmable gate array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A computing system, comprising:
a plurality of components operable to perform computing tasks;
a plurality of memory devices operable to provide memory and storage services to the computing tasks;
a network of physical connections configured between the components and the memory devices to form a bus for the computing tasks to access the memory and storage services; and
a network manager configured to allocate virtual channels, through the bus, for the computing tasks to access the memory and storage services with deterministic timing.

2. The computing system of claim 1, wherein the bus is a time sensitive networking bus.

3. The computing system of claim 1, wherein the plurality of components are configured to provide timing data of the computing tasks to the network manager; and
wherein the network manager is configured to identify, for each of the virtual channels, a set of rules for communications over the bus to guarantee requirements specified in the timing data to be met in a deterministic way.

4. The computing system of claim 1, wherein the network manager is configured to adjust a first virtual channel for a first computing task having a first urgency level, in allocation of a second virtual channel for a second computing task having a second urgency level higher than the first urgency level.

5. The computing system of claim 4, wherein the network manager is configured to adjust the first virtual channel via at least:
a change of a host of data of the first computing task from a first memory device to a second memory device;
a change of a host of the first computing task;
a change of a timing requirement of the first virtual channel; or
a pause of usages of the first virtual channel by the first computing task.

6. The computing system of claim 5, wherein the network manager includes an analog compute module configured to perform at least a portion of inference computations in an analog form.

7. The computing system of claim 6, wherein the analog compute module includes a non-volatile memory cell array having memory cells programmed in a first mode according to weight matrices of an artificial neural network trained to perform at least the portion of the inference computations.

8. The computing system of claim 7, wherein the artificial neural network is trained to predict an aspect of the timing data based on which the second virtual channel is allocated.

9. The computing system of claim 8, wherein each respective memory cell programmed in the first mode in the non-volatile memory cell array is configured to output:
a predetermined amount of current in response to a predetermined read voltage when the respective memory cell has a threshold voltage programmed to represent a value of one; or
a negligible amount of current in response to the predetermined read voltage when the threshold voltage is programmed to represent a value of zero;
wherein each respective memory cell is programmable in a second mode in the non-volatile memory cell array to have a threshold voltage positioned in one of a plurality of voltage regions, each representative of one of a plurality of predetermined values.

10. The computing system of claim 9, wherein the analog compute module further comprises:
voltage drivers; and
current digitizers;
wherein the non-volatile memory cell array includes wordlines and bitlines;
wherein the analog compute module is configured to instruct the voltage drivers to apply voltages to the wordlines according to input bits to cause output currents through memory cells, programmed in the first mode to store a weight matrix, to be summed in the bitlines in an analog form; and
wherein the current digitizers are configured to convert currents in the bitlines as multiple of the predetermined amount of current, representative of digital results of multiplication and accumulation applied to the input bits and the weight matrix.

11. The computing system of claim 10, wherein the analog compute module further includes a logic circuit configured to cause a voltage driver to apply, to a respective wordline:
the predetermined read voltage, when an input bit provided for the respective wordline is one; or
a voltage lower than the predetermined read voltage to cause memory cells on the respective wordline to output negligible amount of currents to the bitlines, when the input bit provided for the respective wordline is zero.

12. A method, comprising:
performing, in a plurality of components of a computing system, computing tasks;
providing, via a plurality of memory devices in the computing system, memory and storage services to the computing tasks;
connecting, via a network of physical connections configured between the components and the memory devices to form a bus, the plurality of components having the computing tasks to access the memory and storage services; and
allocating, via a network manager configured in the computing system, virtual channels in the bus for the computing tasks to access the memory and storage services with deterministic timing.

13. The method of claim 12, wherein the bus is a time sensitive networking bus; and
the method further comprises:
receiving, in the network manager, timing data of the computing tasks, wherein the timing data identifies urgency levels of the computing tasks and latency requirements of the computing tasks in accessing the memory and storage services; and
identifying, by the network manager and for each of the virtual channels, a set of rules for communications over the bus to guarantee latency requirements specified in the timing data to be met in a deterministic way.

14. The method of claim 13, further comprising:
adjusting, by the network manager, a first virtual channel for a first computing task having a first urgency level, in allocation of a second virtual channel for a second computing task having a second urgency level higher than the first urgency level, via at least:
a change of a host of data of the first computing task from a first memory device to a second memory device;
a change of a host of the first computing task;
a change of a timing requirement of the first virtual channel; or
a pause of usages of the first virtual channel by the first computing task.

15. The method of claim 14, further comprising:
performing, by an analog compute module, at least a portion of inference computations in an analog form;
wherein the analog compute module includes a non-volatile memory cell array having memory cells programmed in a first mode according to weight matrices of an artificial neural network trained to perform at least the portion of the inference computations.

16. The method of claim 15, further comprising:
training the artificial neural network to predict an aspect of the timing data based on which the second virtual channel is allocated.

17. The method of claim 16, wherein each respective memory cell programmed in the first mode in the non-volatile memory cell array is configured to output:
a predetermined amount of current in response to a predetermined read voltage when the respective memory cell has a threshold voltage programmed to represent a value of one; or
a negligible amount of current in response to the predetermined read voltage when the threshold voltage is programmed to represent a value of zero;
wherein each respective memory cell is programmable in a second mode in the non-volatile memory cell array to have a threshold voltage positioned in one of a plurality of voltage regions, each representative of one of a plurality of predetermined values.

18. The method of claim 17, wherein the analog compute module further comprises:
voltage drivers; and
current digitizers;
wherein the non-volatile memory cell array includes wordlines and bitlines;
wherein the method further comprises:
instructing the voltage drivers to apply voltages to the wordlines according to input bits to cause output currents through memory cells,
programmed in the first mode to store a weight matrix, to be summed in the bitlines in an analog form;
converting, using the current digitizers, currents in the bitlines as multiple of the predetermined amount of current, representative of digital results of multiplication and accumulation applied to the input bits and the weight matrix; and
causing a voltage driver to apply, to a respective wordline:
the predetermined read voltage, when an input bit provided for the respective wordline is one; or
a voltage lower than the predetermined read voltage to cause memory cells on the respective wordline to output negligible amount of currents to the bitlines, when the input bit provided for the respective wordline is zero.

19. A non-transitory computer storage medium storing instructions which, when executed in a computing system, cause the computing system to perform a method, the method comprising:
receiving, in a network manager of a time sensitive networking bus having a network of physical connections configured between a plurality of components configured to perform computing tasks and a plurality of memory devices configured to provide memory and storage services over the time sensitive networking bus, timing data of the computing tasks, wherein the timing data is configured to identify:
urgency levels of the computing tasks; and
latency requirements of the computing tasks in accessing the memory and storage services; and
allocating, by the network manager, virtual channels in the time sensitive networking bus for the computing tasks to access the memory and storage services with deterministic timing, including identifying, for each of the virtual channels, a set of rules for communications over the time sensitive networking bus to guarantee latency requirements specified in the timing data to be met in a deterministic way.

20. The non-transitory computer storage medium of claim 19, wherein the method further comprises:
adjusting, by the network manager, a first virtual channel for a first computing task having a first urgency level, in allocation of a second virtual channel for a second computing task having a second urgency level higher than the first urgency level, via at least:
a change of a host of data of the first computing task from a first memory device to a second memory device;
a change of a host of the first computing task;
a change of a timing requirement of the first virtual channel; or
a pause of usages of the first virtual channel by the first computing task.
